(19) United States
(12) Patent Application Publication
(10) Pub. No.: US 2008/0087728 A1
(43) Pub. Date: Apr. 17, 2008

(54) Voting-on-paper assistive device

(76) Inventor: Mary Ellen Theisen, Port Ludlow, WA (US)

Correspondence Address: Ellen Theisen, 660 Jefferson Ave, Port Ludlow, WA, 98365, US

(21) Appl. No.: 11/549,171

(22) Filed: Oct. 13, 2006

(51) Int. Cl. G07C 13/00

(52) U.S. Cl. 235/386

(57) ABSTRACT

A non-electronic, accessible paper ballot voting device is presented to assist individuals with disabilities to mark and cast paper ballots privately and independently. The device is composed of one custom “ballot sleeve” for each sheet of a ballot, bound together between front and back opaque covers for privacy. Each sleeve reveals the content of the ballot sheet, protects it from stray marks, and provides holes through which a voter can mark voting choices. A page-turning aid is attached to the outside of each sleeve and cover to assist dexterity-impaired voters in turning the pages. Raised markers affixed to the sleeve beside each cutout provide tactile indications for blind voters. An audio tape interprets the raised markers so listeners know which hole corresponds to which candidate. An opaque, sliding “privacy shield” is attached to the front cover to conceal the ballot as it is being deposited.

### BACKGROUND OF THE INVENTION

Some people with visual or dexterity impairments cannot mark a paper ballot without assistance. Federal law requires all jurisdictions to provide, at every polling place, by Jan. 1, 2006, methods by which disabled people can vote privately and independently. Electronic voter-assist products are expensive and may be incompatible with voting systems currently in use; most such products do not provide assistance for a wide range of dexterity-impairments.

Electronic voting devices such as Direct Record Electronic voting machines, and ballot-marking devices such as the AutoMark Voter Assist Terminal[™], provide assistance to some disabled voters and allow them to vote privately and independently. The only non-electronic voter-assist device in use in the United States is the tactile ballot template, used in Rhode Island. The template system provides tactile and audio assistance to blind and visually-impaired voters. No non-electronic voter-assist device currently exists to assist dexterity-impaired voters to vote privately and independently.

Jurisdictions that do not want to or cannot afford to computerize their election systems have no satisfactory way to comply with federal law. For many jurisdictions that are already computerized, there are no compliant electronic options that are compatible with their current systems. The Non-Electronic Accessible Paper-Ballot Voting Device is an inexpensive, non-electronic voter-assist device that can be used in any jurisdiction and is particularly suited to those that use hand-counted paper ballots or optically-scanned ballots. The Device provides features that assist most people with visual or dexterity impairments to vote privately and independently.

Many jurisdictions with electronic voting machines provide paper ballot backups for occasions when the voting machines break down. Such jurisdictions can provide the Device as a supplement to their systems in order to provide accessible voting during breakdowns.

The ballot for each election in each jurisdiction is unique, and ballots in different precincts in the same jurisdiction may also be unique. Because each Device is specifically constructed to match a unique ballot, the Device must be custom built for each ballot. Therefore, production of the Device is designed to be inexpensive so that the Device can be recycled or discarded after each election.

### BRIEF SUMMARY OF THE INVENTION

The purpose of the Non-Electronic Accessible Paper-Ballot Voting Device is to assist voters with a wide range of disabilities to privately and independently mark and cast paper ballots or mark-sense optically-scanned ballots that are identical to those used by able-bodied voters in the same precinct. The Device is composed of opaque front and back covers enclosing one or more sleeves into which the sheets of the paper ballot are inserted. In elections with multi-sheet ballots, one sleeve is included for each sheet of the ballot. The covers and the sleeve or sleeves are bound together in a manner that allows the Device to lie flat when open and the pages to turn a full 360 degrees.

The front and back of each sleeve reveal the content of the ballot sheet, and cutout holes at the locations where voters mark their choices enable the voter to mark his or her choices on the ballot. The sleeve protects the ballot from stray marks. The sleeve also provides a left inside edge that allows the sleeve to be bound with the covers. Page-turning aids, such as clamps or book rings, are attached to the right outside edge of each cover and sleeve and are offset from each other to assist dexterity-impaired voters in grasping and turning the pages.

The design uses raised tactile indicators affixed to the sleeve beside each cutout to guide voters with visual impairments. An audio tape is created to interpret the raised indicators for blind and visually-impaired voters, so they know which cutout corresponds to which candidate. Instructions can also be provided in Braille and large font. The Device can be set on a table or propped up on an easel, depending on the needs of the voter.

A sliding privacy shield is attached to the front cover of the Device, providing a cover for the ballot when either the voter or a poll worker deposits the ballot into a ballot box or a precinct-based optical scanner. The sliding privacy shield ensures that the privacy of the votes is protected.

### BRIEF DESCRIPTION OF THE SEVERAL VIEWS OF THE DRAWING

FIG. 1. The components of a Voting-on-Paper Assistive Device.

FIG. 2. Holes cut at appropriate locations in one side of the sleeve.

FIG. 3. Perspective view of the top edge; ballot inserted into the slot in the sleeve.

FIG. 4. Perspective view from side; raised markers (tactile indicators) attached to the ballot sleeve.

FIG. 5. Privacy shield construction.

FIG. 6. Pocket construction and attachment to front cover.

FIG. 7. Interaction of the privacy shield and pocket.

FIG. 8. Front cover, sleeve, and back cover bound.

FIG. 9. Page-turning aid attached to page.

FIG. 10. Device assembled, ballot slipped into sleeve.

FIG. 11. Paper ballot being deposited into ballot box and precinct scanner.

### DETAILED DESCRIPTION OF THE INVENTION

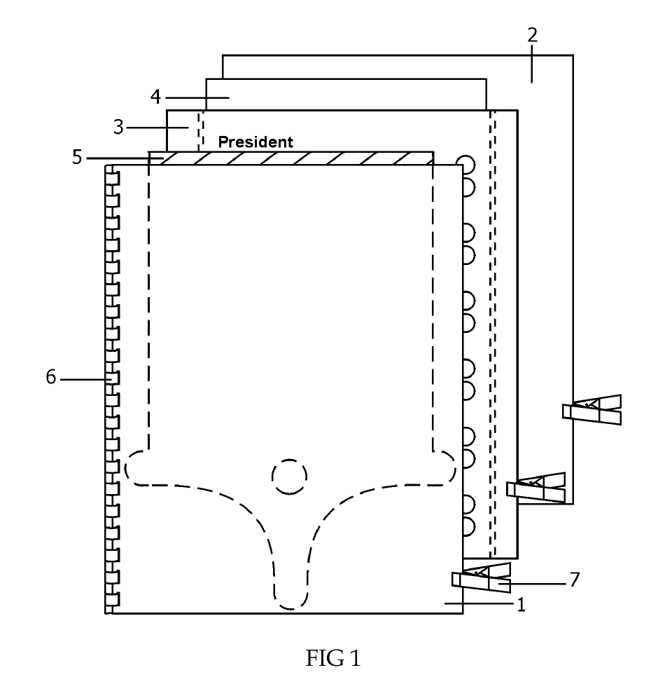

FIG. 1 shows all components of the Device, which is a disposable booklet composed of a front (1) and back (2) cover and one ballot sleeve (3) for each sheet of the ballot (4) to be marked. An opaque, sliding privacy shield (5) inserted into a pocket on the inside of the front cover provides secrecy for the voter's choices when the ballot is deposited in the ballot box or inserted into the optical scanner. All components are bound together (6) such that the booklet can lay flat when open and each page can turn 360 degrees. Page-turning aids are attached to the outside of each page of the device.

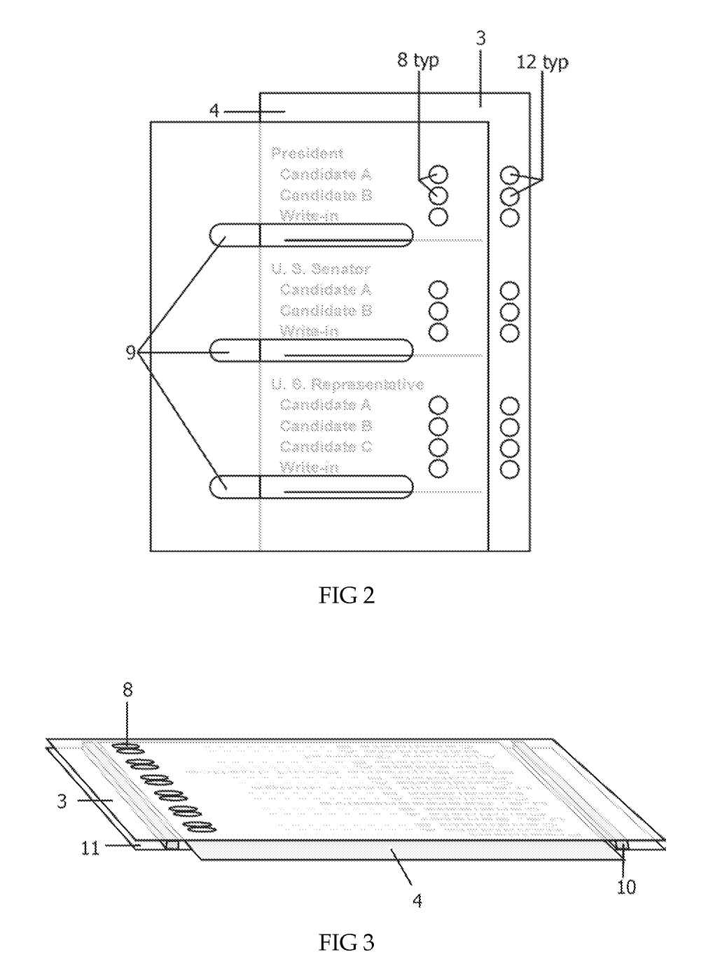

Each half of each ballot sleeve (1), best shown in FIG. 2, is constructed of material that allows the voter to see the content of the ballot sheet as it appears inside the sleeve. A sleeve can be made of two identical ballot sheets laminated and attached together, or the two sides of the sleeve can be transparencies. In the preferred embodiment, each side of each sleeve is composed of one 10 mil rigid transparent sheet. Each sleeve is one inch shorter than the length of the ballot, exposing the top part of the ballot which contains no voter choices, so that the voter or poll worker can easily grasp the ballot and slide it out once the voter has voted.

Each sleeve is wider than the width of the ballot, providing material that allows the two halves of the sleeve to be attached together to form the slot for the ballot. The extra width also allows the sleeve to be bound together with the covers on the left edge and to accept a page-turning aid on the right edge. Each half of each sleeve is customized for the side of the ballot to be marked. Holes (8) are cut or punched at locations in the transparency (or laminated ballot sheet) matching the locations (12) where a voter can mark the ballot sheet to indicate a choice. An elongated hole (9) is cut or punched at each location where a voter can write the name of a write-in candidate.

In many jurisdictions that use paper ballots or optical scan ballots, the ballot image is electronically written to an Acrobat Reader file, which is delivered to a printing house. The printing house prints ballots directly from the electronic file. To produce each half of each individual ballot sleeve, an electronic file based on that same Acrobat Reader file can be created defining the length and width of the sleeve and the size and location of each hole to cut in the sleeve. This electronic file can be delivered to a custom laser cutter as a template for cutting each half of the sleeve.

In extremely small jurisdictions where only a small number of sleeves are needed, the sleeves can be cut to size with a utility knife and the holes can be punched in each half of the sleeve with an inexpensive, custom, hand-held die or punch placed on the transparency (or laminated ballot) and struck with a mallet. In large jurisdictions, when large numbers of identical sleeves are needed for each ballot sheet, an automated process, using dies or a paper drill and the facilities of a printing house, could be used.

FIG. 3 best shows how the two halves of each sleeve are attached together the full length of the sleeve such that when the ballot (4) is fully inserted, the holes (8) in each side of the sleeve (3) match the appropriate locations on the ballot. The top and bottom of the sleeve remain open. In the preferred embodiment, the sides are attached together with two strips of thick ( 1/32″ to 1/16″) double-sided tape or dimension glue (10), each strip placed 1/32″ outside the outline of where the ballot will be positioned when it matches the holes in the sleeve. The thickness of the tape or glue provides a space (11) so the ballot can slip in and out easily. The two halves of the sleeve may be attached with a radio frequency (RF) seal instead of tape or glue.

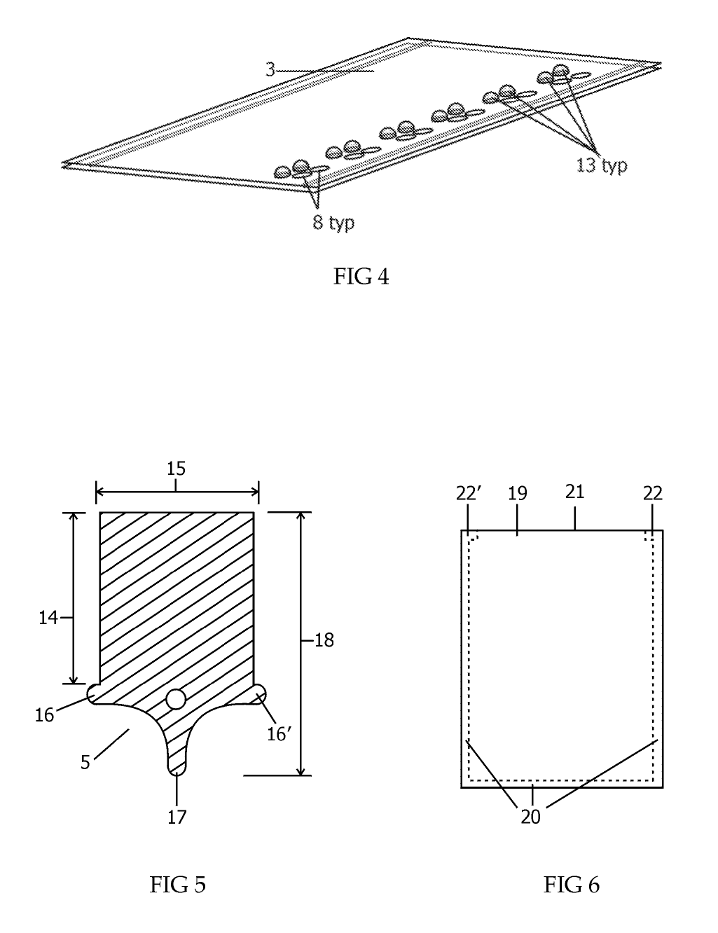

To assist blind and visually-impaired voters, self-adhesive, raised bumps (13), shown best in FIG. 4, made of rubber or dimension paint are affixed to the sleeve, one beside each hole cut in the sleeve to indicate the locations of the cutouts. In the preferred embodiment, clear self-adhering rubber “bump dots”, ⅛-inch by ¼-inch oval, and 1/16-inch high are used. An audio tape is created to interpret the bump dots and cutouts for voters, so they know which cutout corresponds to which candidate. Instructions are also provided in Braille and large font print.

The front (1) and back (2) covers, shown in FIG. 1, are composed of card stock or a plastic sheet. The front is cut to the same length and width as the sleeves. The back is ¼-inch shorter and flush with the bottom of the front and the sleeves.

An opaque privacy shield composed of card stock or a plastic sheet. In the preferred embodiment, the shield is cut in the shape shown in FIG. 5. The length (14) of the shaft is about 9 inches, and the width (15) is the same as the width of the ballot. The tabs (16 and 16′) at the bottom of the privacy shield protrude from the width of the shaft by about ½ inch to ¾ inch on each side of the shaft, such that the overall width is 1-⅛ inch less than the width of the front cover. The tabs are rounded to slide easily inside the front cover, and the bottom edges are curved inward and come together in a rounded point (17) in the middle of the shield. A hole may be cut out of the portion of the shield that remains in the pocket, to reduce the friction and allow the shield to slide in and out more easily. In the preferred embodiment, the overall length (18) of the privacy shield is about ½ inch less than the length of a ballot.

FIG. 6 shows the sheet (19) that attaches to the front cover to form the pocket for the privacy shield. The sheet is composed of card stock or a plastic sheet. In the preferred embodiment, the sheet is cut to the same height and width as the front cover.

The pocket sheet is affixed to the inside of the front cover for about ½ inch running along both sides and the bottom (20). The attached area extends into the top edge (21) of the pocket by about ½ to ¾ inch on each side (22 and 22′).

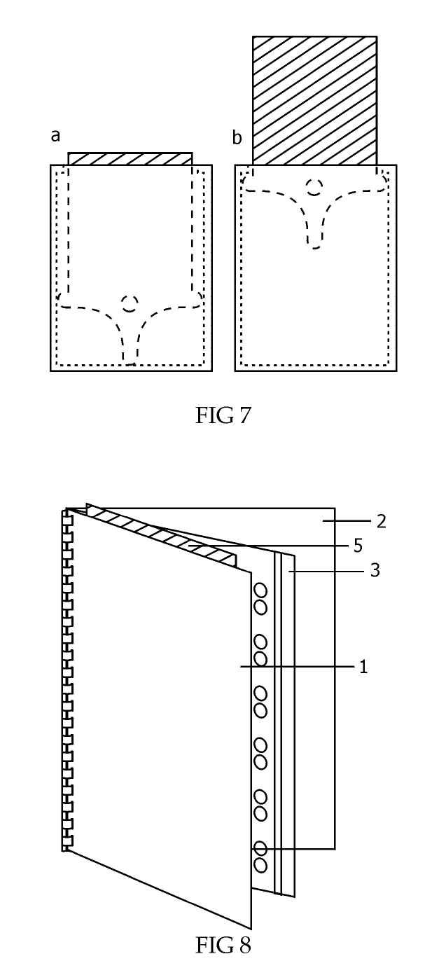

FIG. 7a shows the privacy shield as it sits in the pocket. The tabs are slightly narrower than the opening along the sides of the pocket. The shaft is slightly narrower than the opening at the top. When the privacy shield slides up out of the pocket, as shown in FIG. 7b, the tabs catch on the attachment at the top and prevent the shield from sliding all the way out.

The covers and ballot sleeves are bound together into a booklet, as shown in FIG. 8. The binding is such that it allows the booklet to lie flat when open, and each page can be flipped 360 degrees. The binding does not intrude into the pocket on the inside of the front cover. In the preferred embodiment, either comb binding or coil binding is used.

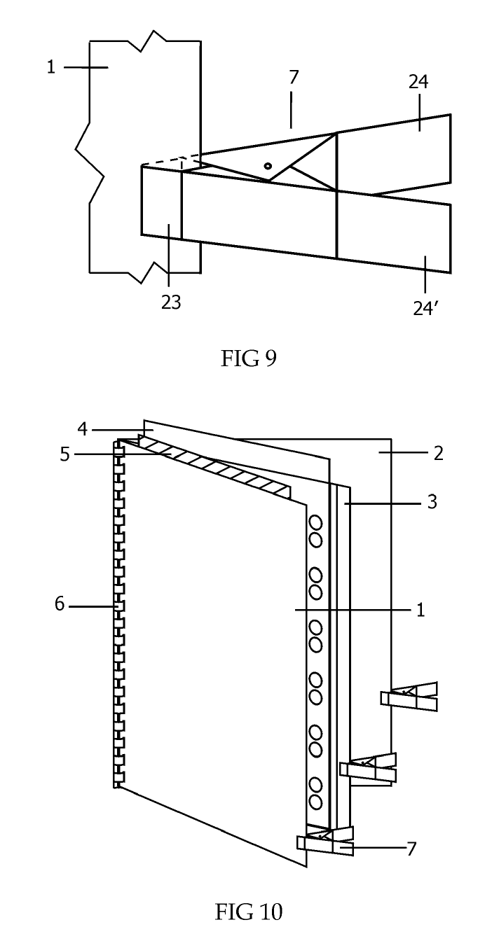

A page-turning aid, as shown in FIG. 9, is attached to the right side of each cover and each sleeve. In the preferred embodiment, page-turning aids are 2-inch spring clamps with rubber tips (23) and rubber handles (24 and 24′). People with dexterity impairments can slide a hand under the clamp or into the opening of the clamp to grasp and turn the page. Since the height of the clamp does not intrude into the booklet, the pages will lay flat as the voter marks the ballot. The aid on the front cover does not extend into the pocket opening. The aids on subsequent pages of the booklet are offset from each other to allow the voter to grasp each one individually to turn the pages of the booklet easily.

FIG. 10 best shows the assembled booklet ready for use. When a ballot sheet is inserted into a sleeve, the bottom of the ballot sheet is flush with the bottom of the sleeve, and the top of the ballot protrudes above, exposing only the part of the ballot that contains no voter choices. The poll worker attaches easy-release, adhesive tape running horizontally along the top, back of the ballot and the top, back of the sleeve to hold the ballot in position in the sleeve. The Device can be set on a utility table, adjustable-height table, or an easel, depending on the needs of the voter.

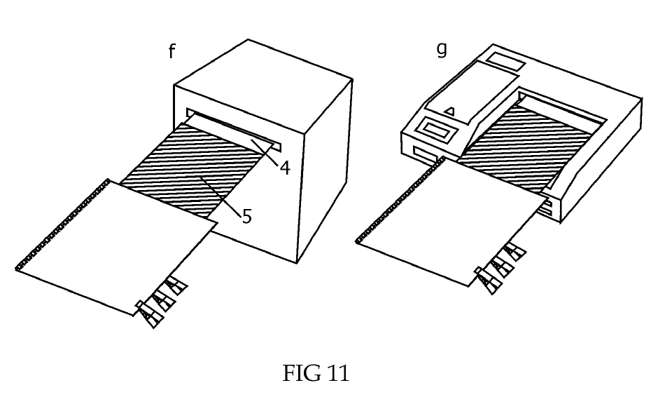

Once the voter has finished voting, the voter or a poll worker removes the easy-release adhesive tape, and the voter or a poll worker can grasp the ballot easily to deposit it, as shown in FIG. 11, into a ballot box (a) or feed it into a precinct-based optical scanner (b). The privacy shield can be grasped with the ballot and pulled out of the pocket the length of the scanner tray to protect the secrecy of the votes as the ballot is deposited.

I claim:

1. A device to assist disabled voters to mark and cast ballots in secrecy, comprising:
a flat, template sleeve, having separate front and back halves, long enough to cover all voting areas of the subject ballot and wider than the ballot such that the front and back halves of the sleeve can be attached to each other to form a slot appropriate for the ballot to be inserted from either the top or bottom, and such that binding holes can be punched on one edge and a page-turning aid can be attached to the other edge.
cutout holes in the front and back halves of each sleeve that match all voting locations on the front and back of the corresponding ballot sheet, such that a disabled voter can mark in the appropriate locations without defacing other areas of the ballot;
two opaque sleeve covers that, when the left edges are flush with the left edge of the sleeve, completely cover voting area of the ballot;
an opaque sliding privacy shield that resides in a pocket in the front cover, slips out to conceal the ballot and the voter's choices as the ballot is slipped out of its sleeve to be deposited in a ballot box or scanner, and yet cannot slide out all the way and be detached from the Device;
binding for the assembled covers and sleeve or sleeves such that each page turns easily, the Device lies flat when open, and the pages can be turned 360 degrees;
page-turning aids attached to the right outer edge of each cover and each sleeve;
tactile indicators consisting of raised markers affixed to the sleeve beside each candidate or issue choice, supplemented by audio, Braille, and large-font printed descriptions of the ballot and interpretation of the location of the tactile indicators sufficient to allow a blind or visually-impaired voter to vote accurately without assistance.
